(19) United States
(12) Patent Application Publication
(10) Pub. No.: US 2012/0272479 A1
(43) Pub. Date: Nov. 1, 2012

(54) HINGE FOR VEHICLE TAILGATE

(75) Inventors: Wolfgang RASEL, Rudesheim (DE); Gregor ZOLEDZKI, Trebur (DE); Sandor BOZO, Taunusstein (DE); Klaus BRANDSCHEID, Geisenheim (DE)

(73) Assignee: GM GLOBAL TECHNOLOGY OPERATIONS LLC, Detroit, MI (US)

(21) Appl. No.: 13/454,150

(22) Filed: Apr. 24, 2012

(30) Foreign Application Priority Data
Apr. 29, 2011 (DE) 10 2011 100 048.1

(51) Int. Cl. E05D 11/10; E05D 5/02

(52) U.S. Cl. 16/319; 16/382

(57) ABSTRACT

A hinge for a vehicle tailgate is provided. The hinge has a first hinge part configured for installation on a vehicle body and having a first base section. A second hinge part is configured for installation on a tailgate and has a second base section. A hinge body is connected to the second base section. A hinge joint is configured to connect the hinge parts such that they pivot about a hinge axis and such that the second hinge part is detachably connected to the first hinge part. Two hinge brackets are connected to the first base section and are configured to accommodate the hinge body. The two hinge brackets are connected to one another in a tension and compression-proof fashion by a connecting section.

### CROSS-REFERENCE TO RELATED APPLICATION

This application claims priority to German Patent Application No. 10 2011 100 048.1, filed Apr. 29, 2011, which is incorporated herein by reference in its entirety.

### TECHNICAL FIELD

The technical field generally relates to automotive engineering and particularly relates to a hinge for a vehicle tailgate.

### BACKGROUND

Tailgates installed in motor vehicles are typically coupled to the car body by means of two tailgate hinges mounted on the upper edge of the tailgate. The tailgate hinge may be realized in many different ways, wherein technically simple constructions, in which pivot pins are accommodated in sleeves in a pivoted fashion, proved advantageous in practical applications. However, such simple tailgate hinges can create problems with respect to the manufacturing technology.

### SUMMARY

A hinge for a tailgate of a vehicle is proposed. The hinge comprises a first hinge part for being installed on a car body, as well as a second hinge part for being installed on the tailgate. The two hinge parts can be connected by a hinge joint such they can be pivoted about a hinge axis. The hinge joint is realized such that the second hinge part can be detachably connected to the first hinge part (nondestructively separable). In this case, the first hinge part features a first base section that is connected to two freely ending hinge brackets arranged opposite of and at a distance from one another. For example, the first hinge part has a flat, planar first base section, to which the two hinge brackets are attached, for example, such that they protrude at least approximately perpendicular from the base section. The second hinge part features a second base section that is connected to a hinge body realized such that it can be accommodated between the two hinge brackets. For example, the second hinge part features a flat, planar second base section to which a bushing-shaped hinge body is attached.

In this respect, the two hinge brackets are connected to one another in a tension and compression-proof fashion by at least one connecting section of the first hinge part such that the two hinge brackets are fixed in position relative to one another. The connecting section therefore makes it possible, in particular, to realize a fixed clearance between the two hinge brackets.

The hinge allows a simple installation of the tailgate on the car body by connecting the hinge joint, as well as a simple removal of the tailgate from the car body by (nondestructively) separating the hinge joint. For example, the tailgate can initially be installed on the car body and, if applicable, adjusted during the manufacture of the vehicle on the assembly line and subsequently removed again, for example, in order to paint a water channel situated on the upper tailgate edge. The tailgate can then be reinstalled on the car body without any problems.

During the installation of the first hinge part on the car body, the first base section is typically deformed. Such a deformation of the first base section is caused by shape tolerances of the car body that are unavoidable in series production, as well as a certain flexibility or suppleness of the car body during the installation of the first hinge part. The connecting section makes it possible to prevent a change of the clearance between the two hinge brackets due to a deformation of the first base section during the installation of the first hinge part on the car body. Consequently, the tailgate can be coupled to the car body without any problems by means of the hinge joint.

This applies, in particular, to the preferred manufacture of the two hinge parts of a material with a relatively small thickness that amounts, for example, to no more than 5 mm and may lie, in particular, in the range between 3 and 4.5 mm depending on the material used. Without corresponding measures, a deformation of the first base section normally results in a change of the clearance between the two hinge brackets in this case such that significant problems can arise during the tailgate installation in the series production of motor vehicles. It is preferred to use thin (steel) sheets or light metal materials for the manufacture of both hinge parts, wherein it would, however, also be conceivable to manufacture the two hinge parts of a non-metallic material such as, for example, plastic or glass fiber-reinforced carbon fibers. Due to the utilization of a thin material, the weight of the vehicle can be reduced such that the fuel consumption can be lowered.

The connecting section connects the two hinge brackets to one another in a tension and compression-proof fashion, wherein its compressive strength is particularly relevant because the two hinge brackets are pressed against one another due to denting of the car body that typically occurs during the installation of the first hinge part such that the connecting section prevents a reduction of the clearance. For this purpose, the connecting section may be configured, for example, in the form of a connecting web or connecting bar, such as in the form of a connecting bar that is attached to the base body. In this regard, a particularly high compressive strength can be realized with simple means and the connecting section can be manufactured in a particularly uncomplicated and cost-efficient fashion with respect to the manufacturing technology.

The first hinge part can be installed on the car body in different ways, wherein the first hinge part may for this purpose feature, for example, at least one mounting bolt, by means of which the first hinge part can be connected to the car body. The mounting bolt is arranged, for example, perpendicular to a first base section of planar design.

In a technically simple embodiment of the inventive hinge, the two hinge brackets are respectively provided with an opening for accommodating a hinge pin that extends through the hinge body in the installed state. The hinge body is for this purpose configured, for example, in the form of a bushing that is designed such that the second hinge part can be pivoted about the hinge pin. In order to secure the hinge pin in its position, it can be fixed by a (nondestructively) detachable or separable securing element such that the two hinge parts can be easily connected to or separated from one another at the hinge joint in order to install or remove the tailgate on/from the car body.

In an embodiment, the hinge features an anti-turning device for securing the rotational position of the hinge pin such that the hinge pin is prevented from (also) turning when the tailgate is pivoted. Due to this measure, the stress on the hinge can be significantly lowered during the pivoting of the tailgate such that wear can also be reduced. For this purpose, it would be possible, for example, to attach a tappet to the hinge pin such that it can positively engage into a corresponding recess of a hinge bracket in order to non-rotatably connect the hinge pin to the two hinge brackets.

A vehicle, particularly a motor vehicle, that is equipped with at least one hinge of the above-described type in order to couple, in particular, a tailgate to the car body is also provided.

It goes without saying that the different embodiments contemplated herein can be realized individually or in any combinations. The characteristics described above and below, in particular, not only can be used in the described combinations, but also in other combinations or by themselves without deviating from the scope of the present invention. In addition, other objects, desirable features and characteristics will become apparent from the subsequent detailed description, and the appended claims, taken in conjunction with the accompanying drawings and this summary.

### DETAILED DESCRIPTION OF THE DRAWINGS

The present invention will hereinafter be described in conjunction with the following drawing figures, wherein like numerals denote like elements, and wherein:

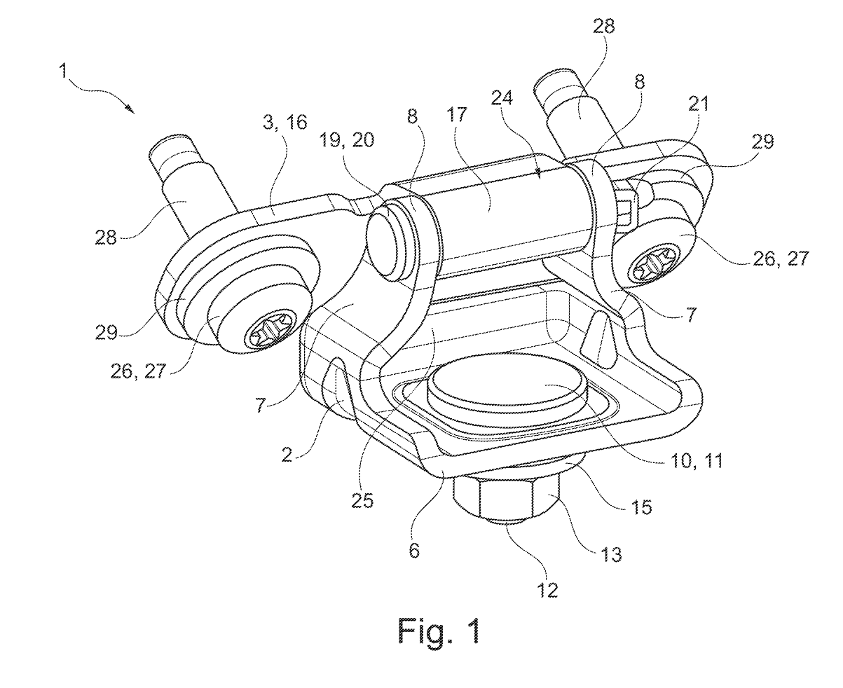

FIG. 1 shows a perspective representation of an exemplary embodiment of the inventive hinge in the installed state;

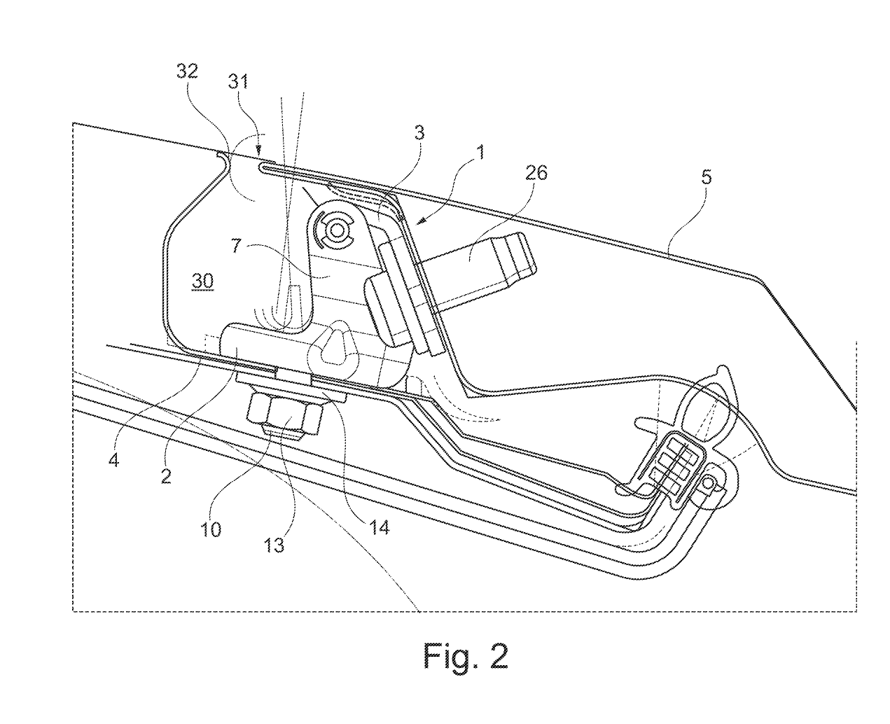

FIG. 2 shows a perspective side view of the hinge according to FIG. 1; and

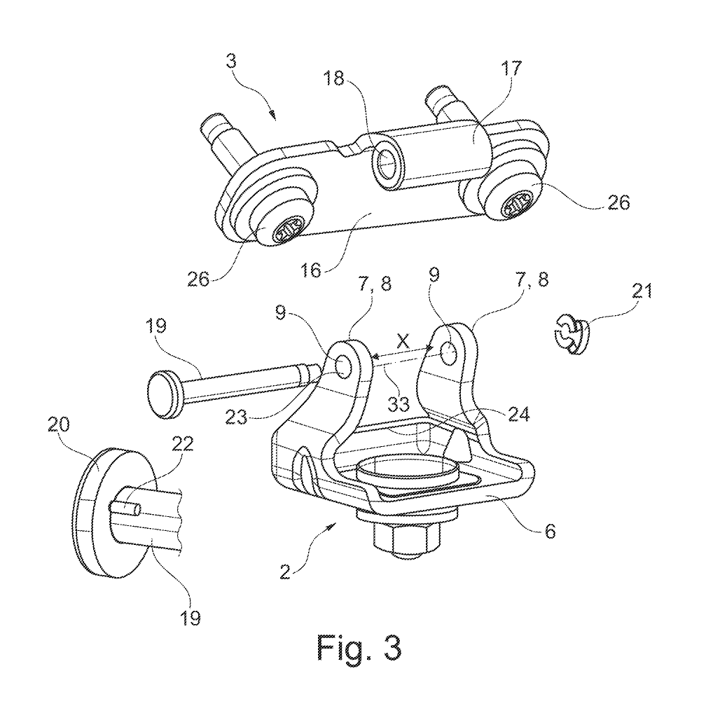

FIG. 3 shows perspective representations of both hinge parts of the hinge according to FIG. 1 in the detached state.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The figures show perspective representations of a hinge that is generally identified by the reference symbol 1 and serves for connecting a tailgate 5 to the car body 4 of a motor vehicle (not shown) in a pivoted fashion. The hinge 1 accordingly comprises a first hinge part 2 that is manufactured of sheet steel and installed on the car body 4 and a second hinge part 3 that is also manufactured of sheet steel and installed on the tailgate 5. Sections of the car body 4 and the tailgate 5 are respectively illustrated in FIG. 2 in the form of a longitudinal section through the vehicle. Although only one hinge 1 is respectively illustrated in the figures, it goes without saying that at least two hinges 1 are normally provided for connecting the tailgate 5.

The first hinge part 2 features a planar, at least approximately flat first base section 6, to which two oppositely arranged hinge brackets 7 are attached. The two freely ending hinge brackets 7 protrude from the first base section 6 approximately perpendicular and have a slightly curved S-shaped contour. On the two end sections 8, the hinge brackets are respectively provided with a circular bracket opening 9.

On the other hand, an about centrally arranged first stud 10 is non-rotatably arranged on the first base section 6, for example, by being pressed therein. In this embodiment, a first bolt shaft 12 of the first stud 10 is provided with an external thread and extends through an opening of the first base section. A first bolt head 11 adjoins the first base section 6. In order to install the first hinge part 2 on the car body 4, the first bolt shaft 12 is inserted into a car body opening 14 and secured with a nut 13. A first washer 15 is arranged between the nut 13 and the car body 4.

The second hinge part 3 features a planar, at least approximately flat second base section 16, to which a hinge bushing 17 is attached. The second hinge part 3 can be easily installed on the tailgate 5 by means of the second base section 16. For this purpose, the second hinge part 3 features openings and through which a second bolt shaft 28 of a second stud 26 respectively extends, wherein the second studs can be secured, for example, with a not-shown nut. In this case, second washers 29 are respectively arranged between the second base section 16 of the second hinge part 3 and the adjoining second bolt heads 27.

In an embodiment, both hinge parts 2, 3 are manufactured of thin sheets and respectively have a thickness that lies in the range between about 3 and about 4.5 mm and amounts, for example, to approximately 3 mm such that the weight of the vehicle can be reduced. However, it would also be conceivable to manufacture the hinge parts 2, 3 of a light metal material such as aluminum or an aluminum alloy or of a non-metallic material, in which case the material thickness may be identical or smaller.

The hinge bushing 17 in the hinge 1 is dimensioned such that it can be inserted into the clearance between the two hinge brackets 7 in a fitted fashion, wherein the two hinge brackets 7 are spaced apart from one another by a distance X. In this case, a bushing hole 18 can be aligned with the two bracket openings 9. A hinge pin 19 can then be inserted through both bracket openings 9 in order to connect the second hinge part 3 to the first hinge part 2, wherein the hinge pin 19 extends through the hinge bushing 17. The hinge pin 19 adjoins one hinge bracket 7 with a pin head 20 and can be fixed on the opposite side by means of a nondestructively removable or detachable retaining ring 21. Since the hinge bushing 17 can be turned relative to the hinge pin 19, the tailgate 5 connected to the second hinge part 3 can be pivoted relative to the car body 4, wherein the hinge pin 19 serves as a pivot bearing and forms a hinge axis 33. In order to prevent the hinge pin 19 from also rotating or to prevent the hinge pin 19 from turning within the bracket openings 9, the hinge pin 19 is provided with a securing tappet 22 that protrudes from the pin head 20 and can engage into a corresponding recess 23 on the bracket opening 9 of the hinge bracket 7 such that the hinge pin 19 is non-rotatably connected to the two hinge brackets 7. This makes it possible to prevent premature wear due to a rotation of the hinge pin 19.

The hinge pin 19, the two hinge brackets 7 and the bracket openings 9 arranged therein, as well as the hinge bushing 17, form a hinge joint 24 that can be easily connected and nondestructively separated. In order to connect the tailgate 5 to the car body 4, the first hinge part 2 is initially installed on the car body 4 and the second hinge part 3 is installed on the tailgate 5, wherein the hinge joint 24 is subsequently connected. In order to connect the hinge joint 24, the hinge pin 19 is inserted through the two bracket openings 9 and the hinge bushing 17 and the retaining ring 21 is subsequently attached. On the other hand, the tailgate 5 can also be easily detached by separating the hinge joint 24. In this regard, the retaining ring 21 is (nondestructively) removed and the hinge pin 19 is pulled out.

This type of removal of a tailgate 5 installed on a car body may be required in the series production of motor vehicles, for example, in order to paint a water channel 30 situated on the upper edge of the tailgate 5. According to FIG. 2, only a small gap 31 exists between the tailgate 5 and an adjacent car body edge 32 when the tailgate 5 is installed such that the water channel 30 cannot be suitably accessed. However, open access to the water channel 30 can be realized due to the option of easily removing the tailgate 5 from the car body 4 by separating the hinge joint 24. In this case, the tailgate 5 can meanwhile be hung on the hinge brackets 7 by means of an auxiliary hinge (not shown), wherein the auxiliary hinge is realized such that open access to the water channel 30 is provided. A worker on the assembly line therefore can easily and ergonomically paint the water channel 30. Subsequently, the tailgate 5 can be once again connected to the car body 4 in the correct position by connecting the hinge joint 24.

On the other hand, the first base section 6 may be deformed when the first hinge part 2 is installed on the car body 4. This deformation is caused by certain shape tolerances of the car body 4 and/or the fact that the car body 4 slightly yields and dents when the stud 10 is tightened. The first base section 6 consisting of a thin sheet adapts to this denting of the car body 4 such that both hinge brackets 7 are subjected to a force that presses together the two hinge brackets and tends to reduce the clearance X between the two hinge brackets 7. However, in an embodiment, a reduction of the clearance X between the two hinge brackets 7 can be prevented with a connecting bar 25 that connects the two hinge brackets 7 to one another in a tension and compression-proof fashion. The connecting bar 25 is attached, for example, to the first base section 6 on the edge thereof and protrudes approximately perpendicular from this first base section 6. It can be easily produced, for example, by beveling an edge section of the first base section 6. The thusly achieved dimensional stability of the two hinge brackets 7 makes it possible to connect the second hinge part 3 to the already installed first hinge part 2 on the car body 4 without significant problems. This dimensional stability is an important prerequisite for the installation, removal and subsequent reinstallation of the tailgate 5 by means of the separable hinge 1. A change of the clearance X between the two hinge brackets 7 can be prevented.

Accordingly, a separable hinge for a tailgate of a vehicle that allows a technically simple installation and removal of the tailgate on/from the vehicle has been provided. A change of the clearance between the hinge brackets can be prevented by means of a connecting section such that the dimensional stability of the hinge brackets on thin hinge parts is ensured.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A hinge for a vehicle tailgate, the hinge comprising:
a first hinge part configured for installation on a vehicle body and having a first base section;
a second hinge part configured for installation on a tailgate and having a second base section;
a hinge body connected to the second base section;
a hinge joint configured to connect the first hinge part and the second hinge part such that the first hinge part and the second hinge part pivot about a hinge axis and such that the second hinge part is detachably connected to the first hinge part;
two hinge brackets connected to the first base section and configured to accommodate the hinge body, wherein the two hinge brackets are connected to one another in a tension and compression-proof fashion by a connecting section.

2. The hinge according to claim 1, wherein the connecting section comprises a connecting bar that is attached to the first base section.

3. The hinge according to claim 1, wherein the first hinge part and the second hinge part are respectively manufactured of a material with a thickness of no more than about 5 mm.

4. The hinge according to claim 1, wherein the first hinge part and the second hinge part are respectively manufactured of sheet steel or a light metal material.

5. The hinge according to claim 1, wherein the first hinge part is configured for being mounted on a car body by a mounting stud.

6. The hinge according to claim 1, wherein the two hinge brackets each comprise a bracket opening for accommodating a hinge pin that extends through the hinge body.

7. The hinge according to claim 6, wherein the hinge pin is configured for being secured by a detachable securing element.

8. The hinge according to claim 6, further comprising an anti-turning device for preventing the hinge pin from rotating.

9. The hinge according to claim 8, wherein the anti-turning device is configured as a tappet that is attached to the hinge pin and engages into a corresponding recess of one of the two hinge brackets.

10. A motor vehicle having a car body to which is connected a tailgate by a hinge, the hinge comprising:
a first hinge part configured for installation on the car body and having a first base section;
a second hinge part configured for installation on the tailgate and having a second base section;
a hinge body connected to the second base section;
a hinge joint configured to connect the first hinge part and the second hinge part such that the first hinge part and the second hinge part pivot about a hinge axis and such that the second hinge part is detachably connected to the first hinge part;
two hinge brackets connected to the first base section and configured to accommodate the hinge body, wherein the two hinge brackets are connected to one another in a tension and compression-proof fashion by a connecting section.

11. The hinge according to claim 10, wherein the connecting section comprises a connecting bar that is attached to the first base section.

12. The hinge according to claim 10, wherein the first hinge part and the second hinge part are respectively manufactured of a material with a thickness of no more than about 5 mm.

13. The hinge according to claim 10, wherein the first hinge part and the second hinge part are respectively manufactured of sheet steel or a light metal material.

14. The hinge according to claim 10, wherein the first hinge part is configured for being mounted on the car body by a mounting stud.

15. The hinge according to claim 10, wherein the two hinge brackets each comprise a bracket opening for accommodating a hinge pin that extends through the hinge body.

16. The hinge according to claim 15, wherein the hinge pin is configured for being secured by a detachable securing element.

17. The hinge according to claim 15, further comprising an anti-turning device for preventing the hinge pin from rotating.

18. The hinge according to claim 17, wherein the anti-turning device is configured as a tappet that is attached to the hinge pin and engages into a corresponding recess of one of the two hinge brackets.
